(19) United States
(12) Patent Application Publication
(10) Pub. No.: US 2026/0362353 A1
(43) Pub. Date: Nov. 12, 2026

(54) BANDWIDTH PART CONSIDERATIONS FOR SSB ADAPTATION IN A TIME DOMAIN

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 19/561,321

(22) Filed: Mar. 9, 2026

Related U.S. Application Data
(60) Provisional application No. 63/803,337, filed on May 9, 2025.

(51) Int. Cl. H04W 56/00; H04W 72/0457; H04W 72/231; H04W 80/02

(52) U.S. Cl. CPC H04W 56/0015; H04W 72/0457; H04W 72/231; H04W 80/02

(57) ABSTRACT

A UE receives, for a first bandwidth part (BWP), a synchronization signal block (SSB) adaptation to an SSB periodicity for a non-cell defining (NCD) SSB. The UE switches from the first BWP to a second BWP. The UE monitors for an SSB in the second BWP based on the SSB periodicity from the SSB adaptation for the first BWP or a different SSB periodicity based on a rule or an indication from a network node.

### CROSS REFERENCE TO RELATED APPLICATION(S)

The present application for patent claims priority under 35 U.S.C. § 119 to U.S. Provisional Patent Application No. 63/803,337 filed May 9, 2025 and entitled “Bandwidth Part Considerations for SSB Adaptation in a Time Domain,” which is assigned to the assignee hereof and hereby expressly incorporated by reference herein.

### TECHNICAL FIELD

The present disclosure relates generally to communication systems, and more particularly, to wireless communication that includes synchronization signal blocks (SSB).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and aspects of future technologies, such as 6G may be based on 5G NR and/or 4G LTE. There exists a need for further improvements in 5G NR and additional wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to receive, for a first bandwidth part (BWP), a synchronization signal block (SSB) adaptation to an SSB periodicity for a non-cell defining (NCD) SSB; switch from the first BWP to a second BWP; and monitor for an SSB in the second BWP based on the SSB periodicity from the SSB adaptation for the first BWP or a different SSB periodicity based on a rule or an indication from a network node.

In an aspect of the disclosure, a method, a computer-readable medium, and an apparatus are provided for wireless communication at a network node. The apparatus is configured to transmit, for a first bandwidth part (BWP) configured for a user equipment (UE), a synchronization signal block (SSB) adaptation to an SSB periodicity for a non-cell defining (NCD) SSB; switch from the first BWP to a second BWP for communication with the UE; and transmit an SSB in the second BWP based on the SSB periodicity from the SSB adaptation for the first BWP or a different SSB periodicity based on a rule or an indication from the network node.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 illustrates an example time diagram showing various aspects of SSB transmission and adaptation, in accordance with various aspects of the present disclosure.

FIG. 5A and FIG. 5B illustrate example aspects of signaling an SSB adaptation to a UE, in accordance with various aspects of the present disclosure.

FIG. 6 illustrates an example time diagram showing various examples of SSB transmission, in accordance with various aspects of the present disclosure.

FIG. 7 illustrates examples of BWPs and SSB resources, in accordance with various aspects of the present disclosure.

FIG. 8 illustrates examples of BWPs and SSB adaptation within BWPs, in accordance with various aspects of the present disclosure.

FIG. 9 is an example communication flow between a UE and a network node including BWP switch and SSB adaptation, in accordance with various aspects of the present disclosure.

FIG. 10A and FIG. 10B are flowcharts of methods of wireless communication, in accordance with various aspects of the present disclosure.

FIG. 11A and FIG. 11B are flowcharts of methods of wireless communication, in accordance with various aspects of the present disclosure.

FIG. 12 is a diagram illustrating an example of a hardware implementation for an example apparatus and/or UE, in accordance with various aspects of the present disclosure.

FIG. 13 is a diagram illustrating an example of a hardware implementation for an example network entity, in accordance with various aspects of the present disclosure.

### DETAILED DESCRIPTION

To reduce power consumption, a network node (e.g., a base station or one or more components of a base station) may use SSB adaptation in the time domain. For example, the network node may adapt or change the periodicity at which the SSB is transmitted by the network node. Adapting the SSB periodicity to a longer length enables the network node to have longer periods of inactivity and provides increased network energy savings.

SSB adaptation in the time domain may be used for some SSBs, such as NCD-SSBs, which may be configured within a BWP configuration. The adaptation of the NCD-SSB periodicity may be indicated to the UE in a DCI or in a MAC-CE received in the corresponding BWP. However, the UE may be configured with multiple BWPs, and different BWPs may have different SSB periodicities. It is unclear whether or how the information signaled to the UE applies to NCD-SSBs in other BWPs. For example, when the UE switches BWPs, the UE does not know which SSB periodicity to use. Aspects presented herein enable the UE to know how to monitor for SSBs for BWPs that may have adapted SSB periodicities.

Particular aspects of the subject matter described in this disclosure can be implemented to realize one or more of the following potential advantages. Aspects presented herein enable a UE and a network node to coordinate so that the UE is aware of a periodicity for monitoring SSB, e.g., with an SSB adaptation, when the UE changes BWPs. The improved communication regarding the SSB adaptation in connection with BWP switches enables the network added flexibility and power savings through the use of SSB adaptation while maintaining effective communication with the UE.

In some aspects, an SSB periodicity may be indicated for all configured BWPs. In some aspects, an SSB periodicity may be indicated for the active BWP only (e.g., and not for non-active BWPs). In some aspects, an SSB periodicity may be indicated for a subset of the BWPs configured for the UE. In some aspects, the signal indicating the SSB adaptation may carry an indication of SSB periodicity adaptation for each configured BWP or a subset of configured BWPs.

When the UE switches to a different BWP, the UE may consider the periodicity of SSB of the new BWP to be a baseline periodicity (e.g., rather than an adapted periodicity), a latest value for the updated periodicity of this BWP, or a configured periodicity value for switching. In some aspects, an assumption for SSB adaptation in the new BWP may be based on the switching method, DCI based, timer based. In some aspects, a DCI or MAC-CE that switches the BWP may indicate to the UE the value to be considered for the SSB subject to adaptation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, among other examples, may be arranged in multiple manners with various components or constituent parts. In a 5G NR or 6G system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

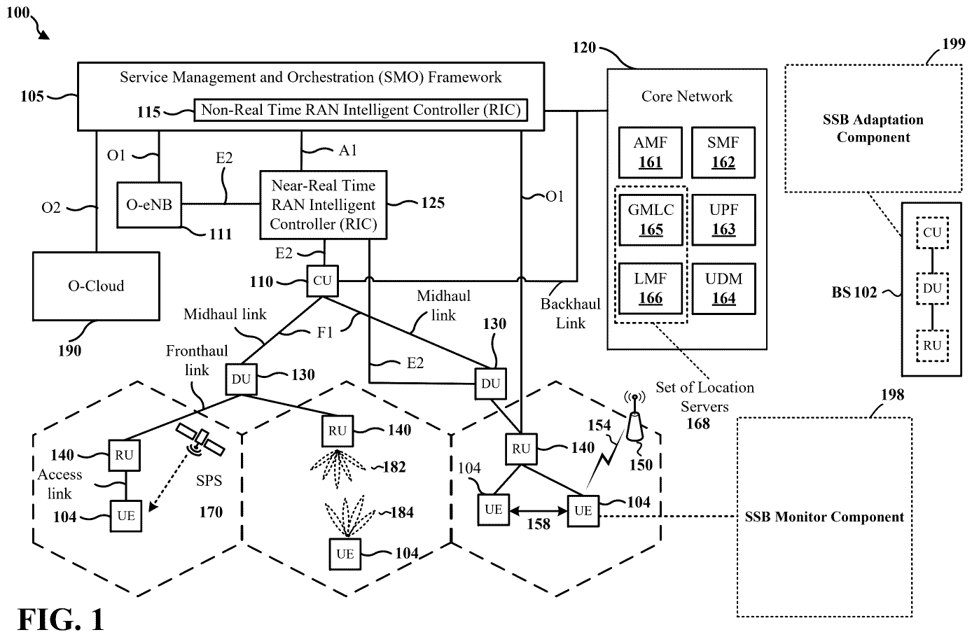

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, as one example, two initial operating bands have been identified as frequency range designations FR1 (410 MHz-7.125 GHz) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band may be used for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend wireless communication operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have am SSB monitor component 198 that may be configured to receive, for a first bandwidth part (BWP), a synchronization signal block (SSB) adaptation to an SSB periodicity for a non-cell defining (NCD) SSB; switch from the first BWP to a second BWP; and monitor for an SSB in the second BWP based on the SSB periodicity from the SSB adaptation for the first BWP or a different SSB periodicity based on a rule or an indication from a network node. In certain aspects, the base station 102 may have an SSB adaptation component 199 that may be configured to transmit, for a first bandwidth part (BWP) configured for a user equipment (UE), a synchronization signal block (SSB) adaptation to an SSB periodicity for a non-cell defining (NCD) SSB; switch from the first BWP to a second BWP for communication with the UE; and transmit an SSB in the second BWP based on the SSB periodicity from the SSB adaptation for the first BWP or a different SSB periodicity based on a rule or an indication from the network node.

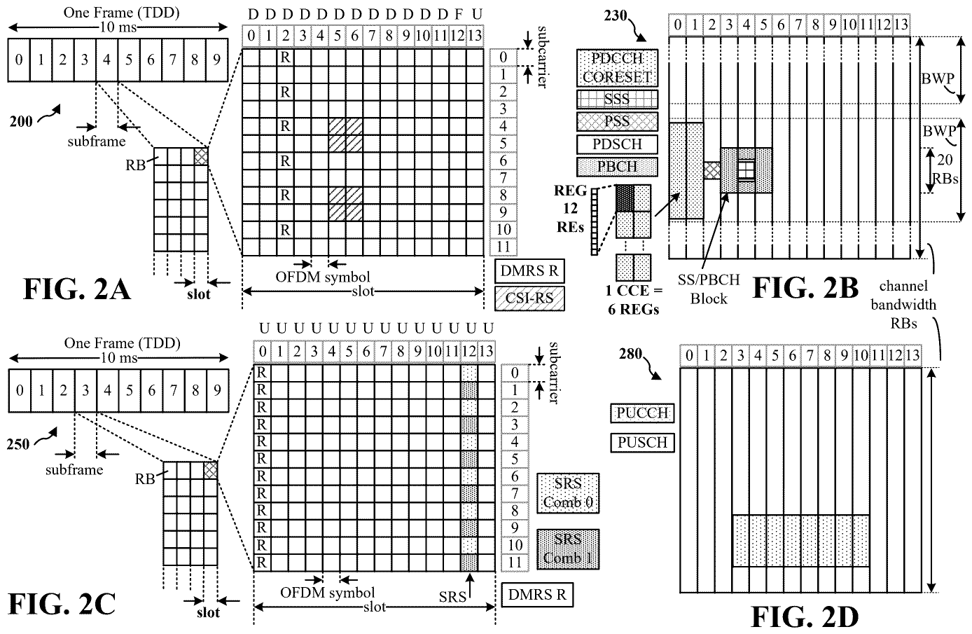

FIG. 2A is a diagram 200 illustrating an example of a first subframe within a frame structure. FIG. 2B is a diagram 230 illustrating an example of DL channels within a subframe. FIG. 2C is a diagram 250 illustrating an example of a second subframe within a frame structure. FIG. 2D is a diagram 280 illustrating an example of UL channels within a subframe. The examples in FIGS. 2A-2D show example aspects of a frame structure based on 5G NR to illustrate the concept of a frame structure and wireless communication based on a frame structure. Various aspects described in connection with FIGS. 2A-2D may also be used in connection with other wireless communication technologies, such as 6G among other examples. The frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

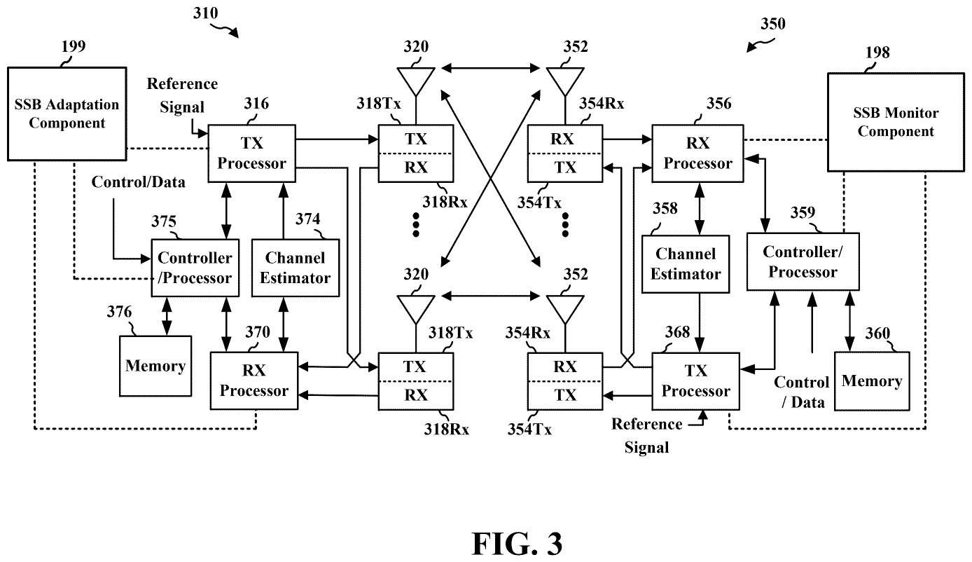

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SSB monitor component 198 of FIG. 1.

At least one of the TX processor 316, the RX processor 370, and the controller/processor 375 may be configured to perform aspects in connection with the SSB adaptation component 199 of FIG. 1.

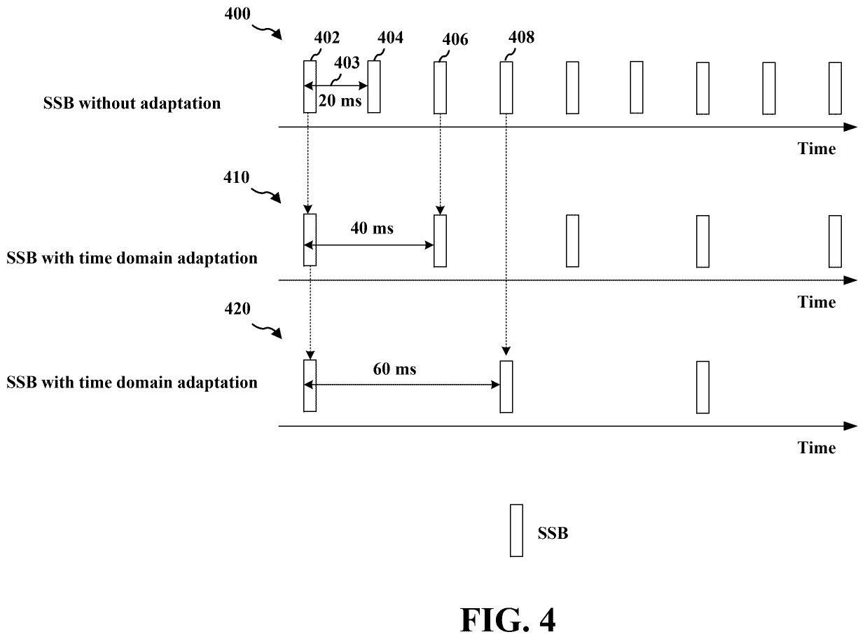

To reduce power consumption, a network node (e.g., a base station or one or more components of a base station) may use SSB adaptation (which may also be referred to as dynamic SSB adaptation) in the time domain. For example, the network node may adapt or change the periodicity at which the SSB is transmitted by the network node. The network node may indicate a dynamic adaptation of the transmitted SSBs. Adaptation of SSB may include dynamically varying the periodicity or transmission pattern of SSB. For example, by adapting the SSB periodicity to a longer length (e.g., dynamic adaptation of SSB transmissions in the time domain to length the period of time between transmissions of the SSB) may enable the network node to have longer periods of inactivity and provide increased network energy savings. As an example to illustrate the concept, FIG. 4 illustrates a time diagram 400 illustrating SSB transmissions without adaptation in the time domain, e.g., including SSB transmissions (e.g., 402, 404, 406, and 408), that occur at SSB occasions based on a 20 ms periodicity. As illustrated, the SSB occasions occur every 20 ms. FIG. 4 shows that with adaptation in the time domain, the SSB transmissions may have a longer periodicity and longer time duration between SSB transmissions. The examples of SSB transmission with time domain adaptation 410 and 420 show that the SSB periodicity can be adapted to have a longer periodicity e.g., 40 ms and 60 ms durations between SSB transmissions.

As an example, for adaptation of SSB in time-domain, e.g., to adapt SSB burst periodicity for an SCell, the network may configure the UE with (or otherwise indicate to the UE) an SSB burst periodicity, e.g., using signalling for the SCell. The UE may be configured with X additional SSB burst periodicity for the SCell, where X has a positive integer value. The SSB occasions with a larger periodicity may be a subset of the SSB occasions with the shorter periodicity. For example, FIG. 4 shows that the adapted SSB shown at 410 include the subset of SSB occasions (e.g., 402 and 406 but not 404 and 408) from the SSB at 400 to extend the periodicity from 20 ms to 40 ms. Similarly, the adapted SSB shown at 420 includes the subset of SSB occasions (e.g., 402 and 408 but not 404 and 406) from the SSB at 400. For example, to achieve the larger periodicity, the network node may skip a subset of the SSB occasions having the shorter periodicity.

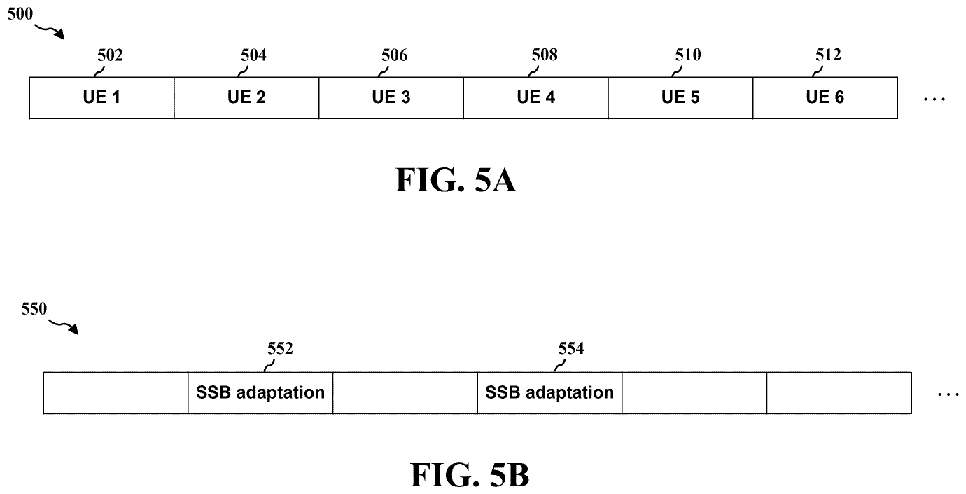

For SSB adaptation in the time-domain by adapting the SSB burst periodicity for an SCell, the adaptation (e.g., the adjusted SSB periodicity) may be indicated in group common DCI signalling. The group common DCI may be a DCI for switching the SSB burst periodicity using DCI format 2_9 with a particular radio network temporary identifier (RNTI) such as an RNTI for cell discontinuous transmission (DTX) (e.g., which may be referred to as “cellDTRX-RNTI”) or a new RNTI that is associated with SSB adaptation. In some aspects, the UE may use the same search space and DCI size as that of cell DTX or cell discontinuous reception (DRX) DCI, e.g., if the network node configures both. For DCI format 2_9 that indicates the SSB burst periodicity adaptation for an SCell, the starting location of the information block for the SSB burst periodicity indication for an SCell within the DCI format 2_9 may be configured. For example, the UE may determine the starting location of the information block within the DCI format 2_9 to check for the SSB adaptation information based on an RRC parameter that indicates the location within the DCI format 2_9. FIG. 5A and FIG. 5B illustrate various examples of a group common DCI that may carry information for multiple UEs. In the example 500 in FIG. 5A, each UE may have a different location within the DCI to receive information about SSB adaptation, e.g., a first UE may receive information at location 502, a second UE may receive information at location 504, a third UE may receive information at a third location 506, a fourth UE may receive information at a fourth location 508, a fifth UE may receive information at a fifth location 510, and a sixth UE may receive information at a sixth location 512. Each UE may receive a configuration, e.g., RRC configuration, that indicates the location within the group common DCI for the UE to receive the SSB adaptation information. In the example 550 in FIG. 5B, multiple UEs may receive information in the same location of the group common DCI yet may interpret the information differently based on individual RRC configurations for the individual UEs. For example, a first UE and a second UE may both receive an indication of an SSB adaptation in a same location within the DCI, yet may apply the SSB adaptation differently based on their individual RRC configurations of how to interpret the information at that location within the DCI. Among other examples, a first UE may receive an RRC configuration that the SSB adaptation indicated at 552 is for BWP 1 configured for the first UE and the SSB adaptation indicated at 554 is for BWP 2 configured for the first UE. In contrast, a second UE may receive an RRC configuration that the SSB adaptation indicated at 552 is for BWP 2 configured for the second UE and the SSB adaptation indicated at 554 is for BWP 3 configured for the second UE.

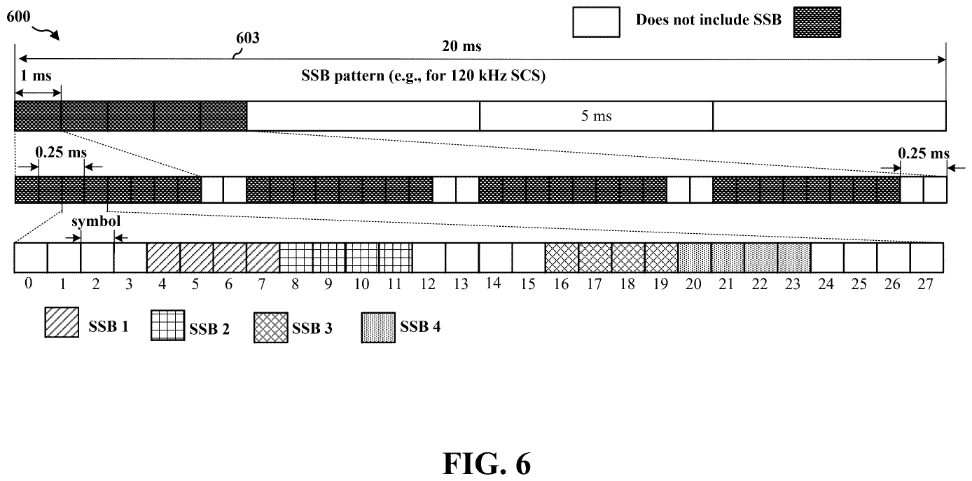

A UE may monitor for SSBs based on sets of multiple SSBs. The set of multiple SSBs may be referred to as an SSB burst set. There may be multiple SSB burst set patterns. FIG. 6 illustrates a time diagram 600 with a pattern for an SSB burst set within a 20 ms time period. FIG. 6 shows that 5 ms within the 20 ms may include SSBs, and the remaining 15 ms may be a time gap between SSBs. FIG. 6 further illustrates that within the 5 ms containing the SSBs of the SSB burst set, there may be additional gaps provided, e.g., 0.25 ms gaps between 1 ms periods that do include SSBs. As an example, the 5 ms period with the SSBs in FIG. 6 may correspond to the SSB occasion 402 in the 20 ms time period 403 that corresponds to the 20 ms timer period 603. Each 0.25 ms period that includes SSBs, may span a set of 28 symbols (e.g., shown as symbols 0-27). FIG. 6 illustrates a pattern with a gap of 4 symbols (symbols 0-3) that do not include an SSB, followed by the consecutive transmission of two SSBs (e.g., SSB 1 on symbols 4-7 and SSB 2 on symbols 8-11). A gap (at symbols 12-15) without SSBs is provided at symbols 12-15, followed by the consecutive transmission of SSB 3 on symbols 16-17 and SSB 4 on symbols 20-23. The time period ends with a gap without symbols on symbols 24-27. In some examples, the period of time may correspond to a 20 ms period. Although the symbol level pattern is only illustrated in FIG. 6 for a single 0.25 ms period, the SSB burst set may correspond to the 20 ms time period, with SSBs transmitted using a similar, or repeating, pattern throughout the 5 ms period shown, e.g., for up to 64 SSBs in the 20 ms period. An SSB burst set may refer to a set of SSB occasions, or SSB transmissions, within a period of time.

In some aspects, the length of the information block may be given by ceil (log 2(1+X)), where the UE is configured with X additional SSB burst periodicities for the SCell. For adaptation of SSB in the time-domain, the UE can be configured with X (<=Xmax) additional SSB burst periodicities for an SCell. In some aspects, Xmax=2.

A UE may be configured with multiple BWPs. FIG. 4 illustrates an example of three BWPs, e.g., BWP 1, BWP2, and BWP3, each spanning a set of frequency resources, e.g., a set of PRBs. A BWP may be activated for the UE from the set of configured BWPs. The UE may not be expected to receive PDSCH, PDCCH, CSI-RS, TRS, etc. outside of an active downlink BWP. The UE may not transmit PUSCH or PUCCH outside of an active uplink BWP. The UE may receive an indication from a network to switch from a first active BWP to a second active BWP from the set of configured BWPs. Each downlink BWP may include a control resource set (CORESET) that corresponds to a configurable set of physical resources in time and frequency that a UE uses to monitor for PDCCH/DCI when the corresponding BWP is activated. In some aspects,

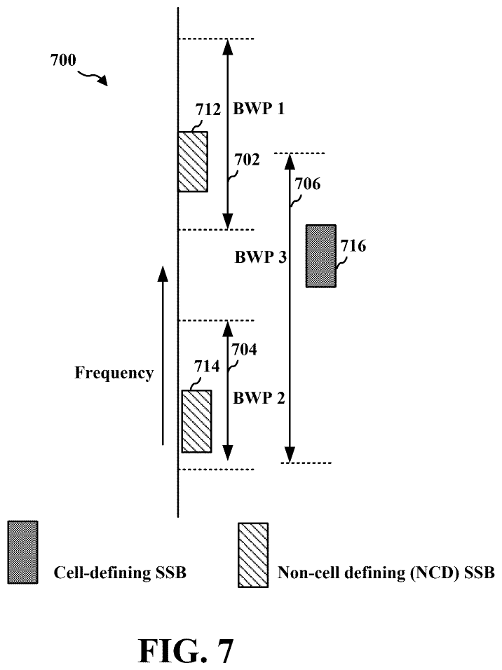

In some aspects, there may be different types of SSBs transmitted by a network node. For example a cell defining SSB (CD-SSB) may be provided for initial cell discovery and may include cell information, such as a cell identifier, a location of a SIB1. In contrast, a non-cell defining SSB (NCD-SSB) may not carry a cell identity or location data for initial attachment to the cell. The NCD-SSB may be used by UEs to perform certain tasks within a particular BWP, such as timing synchronization, performing measurements, (e.g., radio link measurement (RLM), beam failure detection (BFD), and radio resource management (RRM), etc.). The NCD-SSB may be more power efficient than a CD-SSB. In some aspects, the CD-SSB (e.g., 716) may be outside of a BWP, such as shown for BWP 1 702 and BWP 2 704 in the example 700 FIG. 7. The use of the NCD-SSB (e.g., 712 or 714) within BWP enables a UE whose active BWP is BWP 1 to maintain synchronization and perform measurements without switching BWPs (e.g., without switching to BWP 3 706 to receive the CD-SSB 716).

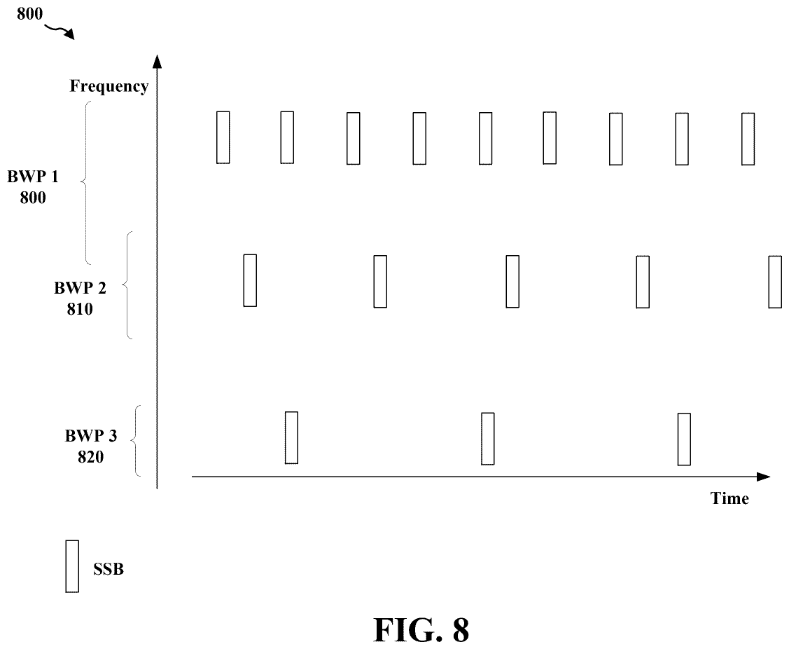

SSB adaptation in the time domain may be used for NCD-SSBs. An NCD-SSB may be configured within a BWP configuration, and the adaptation of the NCD-SSB (e.g., adjustment of the periodicity as described in connection with FIG. 4) may be indicated in a DCI (e.g., DCI format 2_9 as described in connection with FIG. 5A or 5B) or in a MAC-CE. However, the UE may be configured with multiple BWPs, and different BWPs may have different SSB periodicities, it is unclear whether and how the information signaled to the UE applies to NCD-SSBs in other BWPs. FIG. 8 illustrates a time and frequency diagram 800 showing that different BWPs (e.g., 800, 810, and 820) may have different periodicities for SSB. For example, when the UE switches BWPs, the UE does not know which SSB periodicity to use. Aspects presented herein enable the UE to know how to monitor for SSBs for BWPs that may have adapted SSB periodicities.

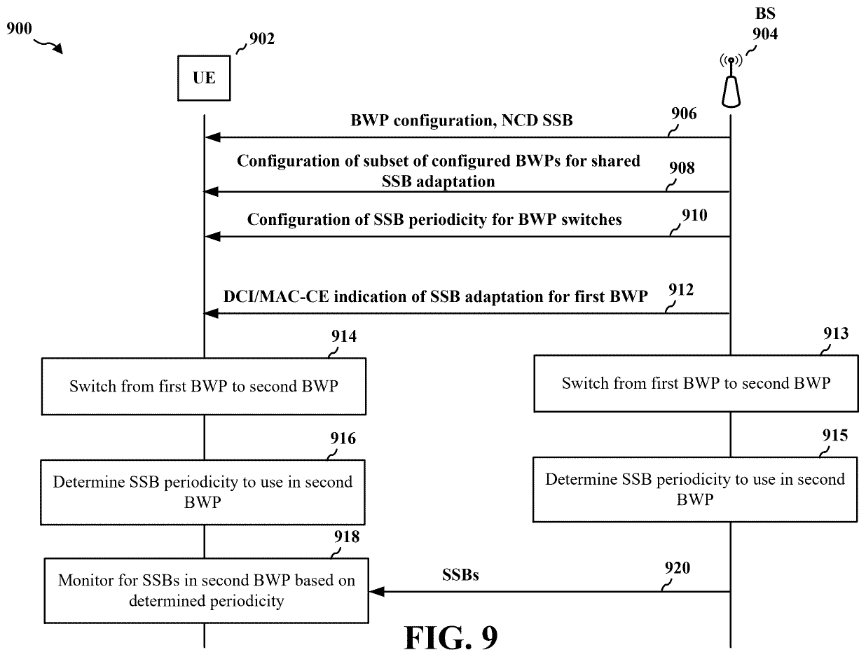

FIG. 9 illustrates an example communication flow 900 between a UE 902 and a network node 904. The aspects performed by the network node 904 may be performed by a base station in aggregation or by one or more components of a disaggregated base station (e.g., a CU, DU, and/or RU). FIG. 9 illustrates that the network node may transmit a BWP configuration 906 to the UE 902 for one or more configured BWPs. The BWP configurations may include a configuration for a NCD-SSB. As described herein, the UE 902 may receive an adaptation of the NCD-SSB periodicity, at 912. The change in the SSB periodicity for one or more BWPs of the UE may be indicated in a DCI (e.g., DCI format 2_9) or a MAC-CE. For example, the UE 902 may receive the DCI or the MAC-CE that indicates the SSB adaptation in a first BWP that is the active BWP for the UE at the time. The UE may monitor for SSB (e.g., NCD-SSB) in that active BWP based on the indicated SSB adaptation, e.g., at the indicated periodicity. At 914, the UE 902 may switch BWPs, e.g., switching from a first active BWP to a second active BWP. The switch may be based on an indication from the network node 904 (e.g., such as in a DCI) or based on expiration of a timer, e.g., without a DCI from the network node. At 916, the UE 902 may determine the SSB periodicity to use to monitor for SSB in the second BWP. Various different considerations are presented herein that the UE may consider for the determination at 916. At 918, the UE monitors for SSBs 920 in the second BWP based on the periodicity determined at 918. Similarly, the network node 904 may switch BWPs, at 913, for communication with the UE 902. At 915, the network node may determine the SSB periodicity to use to transmit the SSBs 920 in the second BWP.

In some aspects, the SSB periodicity may be configured under all configured BWPs. As an example, the UE 902 may apply the indicated SSB adaptation received at 912 (e.g., whether received in DCI or MAC-CE) to all BWPs configured for the UE. For example, if the UE 902 receives an indication in DCI or a MAC-CE for an SSB adaptation to an adjusted SSB periodicity, the UE 902 may apply the indicated SSB periodicity for all BWPs configured for the UE. Thus, if the SSB periodicity is indicated for BWP 1, and the UE then switches to BWP 2 at 914, the UE monitors for SSB, at 918, in BWP 2 based on the SSB periodicity indicated for BWP 1, at 912.

In some aspects, the SSB periodicity indicated in an SSB adaption may be configured under the active BWP (e.g., and not other BWPs configured for the UE). For example, the UE 902 may apply the SSB adaptation indicated at 912 (e.g., whether received in DCI or MAC-CE) for the active BWP in which the indication was received and not for other BWPs to which the UE may switch. In this example, the UE 902 uses a different (e.g., independent or separate) SSB periodicity than the periodicity indicated at 912 to monitor for the SSB at 918.

In some aspects, the SSB periodicity may be configured under a subset of the BWPs. For example, the UE 908 may receive a configuration (e.g., RRC configuration) or other indication, of a set of one or more BWPs, at 908. For example, the set of BWPs may be a subset of the BWPs configured for the UE and may be indicated for shared SSB adaptation. If the SSB adaptation is signaled for (or in) one of the BWPs in the indicated set of BWPs, the UE may determine that the SSB periodicity is applicable for each of the BWPs in the set. For example, the UE 902 may be configured with BWP 1, BWP 2, BWP 3, and BWP 4 at 906, and the UE 902 may receive an indication, at 908, that BWP 1 and BWP 4 are grouped for the purposes of SSB adaption in the time domain. If the UE 902 has BWP 1 as the active BWP and receives an indication (e.g., in DCI or MAC-CE) at 912 for an adapted SSB periodicity for BWP 1, the UE 902 monitors for SSB based on the adapted periodicity in BWP 1. If the UE 902 switches to BWP 4, at 914, the UE also monitors, at 920, for the SSB based on the adapted periodicity indicated in BWP 1 (because BWP 4 is in the set with BWP 1). However, if the UE 902 switches to BWP 2, at 914, the UE does not use the adapted SSB periodicity that was indicated for BWP 1 to monitor for the SSBs at 918, and instead will determine, at 916, a separate SSB periodicity to use.

In some aspects, the SSB adaptation signaled (e.g., in DCI format 2_9 or MAC-CE) to the UE 902, at 912, may carry an indication of an SSB periodicity adaptation for each configured BWP of the UE. For example, the UE may be configured with BWP 1, BWP 2, BWP 3, and BWP 4, and the UE may receive an indication in DCI or a MAC-CE with a first SSB adaption for BWP 1, a second SSB adaption for BWP 2, a third SSB adaption for BWP 3, and a fourth SSB adaptation for BWP 4. In some aspects, the SSB adaptation signaled (e.g., in DCI format 2_9 or MAC-CE) may carry an indication of an SSB periodicity adaptation for a subset of configured BWPs of the UE. For example, the UE may be configured with BWP 1, BWP 2, BWP 3, and BWP 4, and the UE may receive an indication in DCI or a MAC-CE with a first SSB adaption for BWP 2, and a second SSB adaptation for BWP 4 (e.g., without an SSB adaptation for BWP 1 and BWP 3). FIG. 5B illustrates an example of a DCI that may carry SSB adaptation information for more than one BWP. In this example, the UE 902 may determine the SSB periodicity to use in the second BWP, at 916, because the UE has previously received the value for the second BWP.

In some aspects, when the UE 902 switches BWPs (e.g., from a first active BWP to a second active BWP) at 914, the UE may consider the SSB periodicity in the second BWP to be a baseline periodicity (e.g., rather than an adapted periodicity indicated in a prior BWP). For example, the BWP switch may trigger a return to a baseline periodicity. The baseline periodicity may be the periodicity configured for the SSB in that BWP, for example (e.g., without SSB adaptation).

In some aspects, when the UE 902 switches BWPs (e.g., from a first active BWP to a second active BWP) at 914, the UE 902 may consider the SSB periodicity in the second BWP to be latest value for the updated periodicity of this BWP (e.g., the second BWP). In some aspects, the UE may consider the SSB periodicity to be the last indicated SSB periodicity. For example, a UE in BWP 1 may receive an SSB periodicity in BWP 1 and use the indicated SSB periodicity to monitor for SSB in BWP 1. The UE may switch to BWP 2 and later switch back to BWP 1. The UE may again apply the previously received SSB periodicity indicated for BWP 1 (e.g., as the latest received in BWP 1) even if the UE received intervening SSB adaptions for BWP 2 while BWP was the active BWP. In some aspects, if the UE received a second SSB adaptation while in BWP 2, the UE may apply that SSB adaptation upon the return to the BWP 1, because it was the last received SSB adaptation.

In some aspects, when the UE 902 switches BWPs at 914 (e.g., from a first active BWP to a second active BWP), the UE may apply a configured periodicity value for switching. For example, prior to a BWP switch, the UE may receive, at 910, a configuration or other indication of an SSB periodicity to use when switching BWPs. The configuration may indicate a single value for the UE to use when switching BWPs after an SSB adaptation. If the active BWP for the UE switches from BWP 1 to BWP 2, the UE may change from using an adapted SSB periodicity indicated for BWP 1 and instead monitor for SSB in BWP 2 based on the SSB periodicity value previously configured for BWP switching scenarios. In some aspects, the SSB periodicity value for BWP switching scenarios may include multiple values that depend on the BWPs involved in the switch (e.g., a last BWP and a new BWP). Table 2 illustrates an example table showing different periodicity values that may be configured for BWP switches between particular BWPs and directions of the change. For example, the rows may indicate the prior BWP, and the columns may indicate the new BWP after the switch.

TABLE 2

| | BWP 1 | BWP 2 | BWP 3 |
|---|---|---|---|
| BWP 1 | | First | Second |
| | | periodicity | periodicity |
| BWP 2 | First | | Third |
| | periodicity | | periodicity |
| BWP 3 | Fourth | First | |
| | periodicity | periodicity | |

In some aspects, when the UE 902 switches BWPs (e.g., from a first active BWP to a second active BWP) at 914, the UE 902 may determine, at 916, the SSB periodicity to use in the new BWP by considering further information. As an example the SSB periodicity assumption may be based on the switching method (e.g., whether DCI based, timer based, etc.). As an example, the UE may apply one assumption about the SSB periodicity in the new BWP when the BWP switch was triggered by a DCI indication from the network. In contrast, the UE may apply a different assumption about the SSB periodicity in the new BWP if the BWP switch was triggered by a timer expiration (e.g., and without DCI signaling from the network). As an example, the UE may apply a configured SSB periodicity from table 2 if the BWP switch is indicated in a DCI from the network node. If the BWP switch is based on a timer expiration, the UE may instead use a baseline SSB periodicity in the new BWP.

In some aspects, the signaling from the network node 904 (e.g., such as a DCI or MAC-CE at 912) that indicates for the UE 902 to switch BWPs may indicate an SSB adaption value for the UE to use in the new BWP. In some aspects, the signaling from the network node that indicates for the UE to switch BWPs may indicate an SSB adaptation assumption or method to be applied by the UE for the new BWP (e.g., whether to use a last signaled value, a table of configured values, a baseline value, etc.).

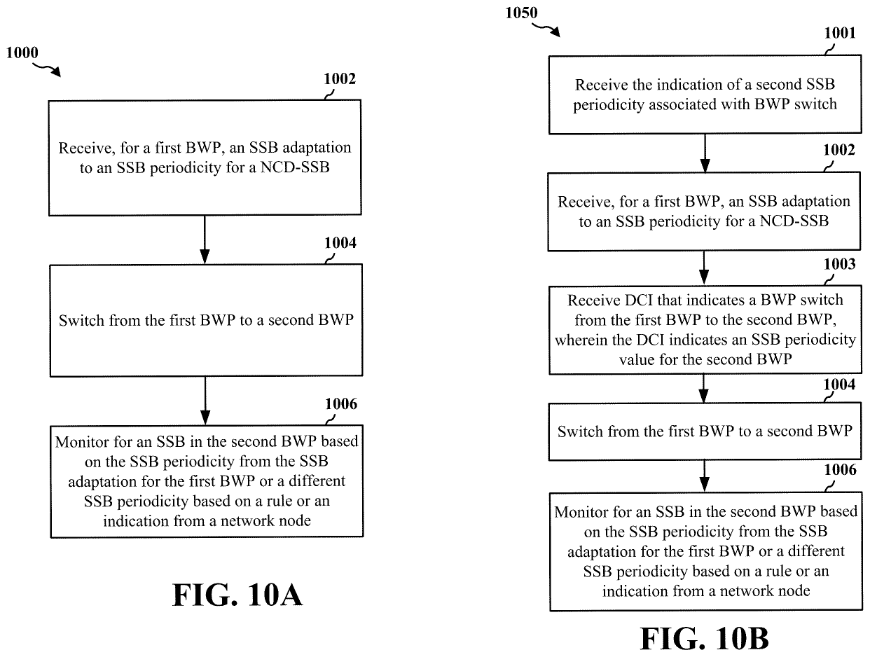

FIG. 10A is a flowchart 1000 of a method of wireless communication. The method may be performed by a UE (e.g., the UE 104, 350, 902; the apparatus 1204). The method enables a UE and a network node to coordinate so that the UE is aware of a periodicity for monitoring SSB, e.g., with an SSB adaptation, when the UE changes BWPs. The improved communication regarding the SSB adaptation in connection with BWP switches enables the network added flexibility and power savings through the use of SSB adaptation while maintaining effective communication with the UE.

At 1002, the UE receives, for a first bandwidth part (BWP), a synchronization signal block (SSB) adaptation to an SSB periodicity for a non-cell defining (NCD) SSB. The reception may be performed, e.g., by one of more of the SSB monitor component 198, the transceiver 1222, and/or the antenna 1280. FIG. 6 illustrates an example of a UE 902 receiving an indication at 912. FIG. 4 and FIG. 8 illustrate example aspects of SSB adaptation, and FIGS. 5A and 5B illustrate examples of a DCI that may indicate the SSB adaptation. In some aspects, the SSB adaptation applies to all BWPs configured for the UE. In some aspects, the SSB adaptation applies to an active BWP in which an SSB adaptation indication is received and not to other BWPs configured for the UE. In some aspects, the SSB adaptation applies to a subset of BWPs configured for the UE. In some aspects, the SSB adaptation may be indicated in a downlink control information (DCI) (e.g., DCI format 2_9) or a medium access control-control element (MAC-CE) that indicates multiple SSB adaptations including an SSB periodicity value for each BWP configured for the UE. In some aspects, the SSB adaptation may be indicated in a downlink control information (DCI) or a medium access control-control element (MAC-CE) that indicates multiple SSB adaptations including an SSB periodicity value for a subset of BWPs configured for the UE.

At 1004, the UE switches from the first BWP to a second BWP. The switch may be performed, e.g., by one of more of the SSB monitor component 198, the transceiver 1222, and/or the antenna 1280. FIG. 9 illustrates an example of a UE switching from a first active downlink BWP to a second active downlink BWP. FIG. 7 and FIG. 8 illustrate example aspects relating to BWPs. In some aspects, the UE may receive a downlink control information (DCI) indicating a BWP switch from the first BWP to the second BWP, and the UE may switch BWPs based on reception of the DCI.

At 1006, the UE monitors for an SSB in the second BWP based on the SSB periodicity from the SSB adaptation for the first BWP or a different SSB periodicity based on a rule or an indication from a network node. The monitoring may be performed, e.g., by one of more of the SSB monitor component 198, the transceiver 1222, and/or the antenna 1280. FIG. 9 illustrates an example of monitoring for an SSB after a BWP switch, at 918. In an example where the SSB adaptation applies to all BWPs configured for the UE, the UE monitors for the SSB in the second BWP based on the SSB adaptation. If the SSB adaptation applies to an active BWP in which an SSB adaptation indication is received and not to other BWPs configured for the UE, the UE monitors for the SSB in the second BWP based on a different (or separate) SSB periodicity than the SSB adaptation. If the SSB adaptation applies to a subset of BWPs configured for the UE, the UE monitors for the SSB in the second BWP based on the SSB adaptation if the second BWP is in the subset and monitors for the SSB in the second BWP based on a different (or separate) SSB periodicity than the SSB adaptation if the second BWP is not in the subset. In some aspects, the UE monitors for the SSB in the second BWP based on a baseline SSB periodicity that is different than the SSB periodicity indicated in the SSB adaptation for the first BWP. In some aspects, the SSB adaptation for the first BWP is a last SSB periodicity indicated to the UE, and the UE monitors for the SSB in the second BWP based on the SSB periodicity indicated in the SSB adaptation as the last SSB periodicity indicated to the UE.

In some aspects, the UE may further receive the indication of a second SSB periodicity associated with BWP switching, and the UE monitors for the SSB in the second BWP based on the second SSB periodicity. In some aspects, a value of the second SSB periodicity may be based on the first BWP and the second BWP. In some aspects, the UE monitors for the SSB in the second BWP based on the SSB periodicity from the SSB adaptation for the first BWP or the different SSB periodicity based on a type of BWP switch. If the UE received a DCI indicating a BWP switch from the first BWP to the second BWP, where the DCI indicates an SSB periodicity value for the second BWP, the UE may monitor for the SSB in the second BWP based on the indicated SSB periodicity value from the DCI indicating the BWP switch.

The method may further include any of the aspects performed by the UE in the communication flow in FIG. 9, and/or any of the aspects described in connection with FIGS. 1-8.

FIG. 10B is a flowchart 1050 of a method of wireless communication. The method may be performed by a UE (e.g., the UE 104, 350, 902; the apparatus 1204). The method enables a UE and a network node to coordinate so that the UE is aware of a periodicity for monitoring SSB, e.g., with an SSB adaptation, when the UE changes BWPs. The improved communication regarding the SSB adaptation in connection with BWP switches enables the network added flexibility and power savings through the use of SSB adaptation while maintaining effective communication with the UE.

At 1002, the UE receives, for a first bandwidth part (BWP), a synchronization signal block (SSB) adaptation to an SSB periodicity for a non-cell defining (NCD) SSB. The reception may be performed, e.g., by one of more of the SSB monitor component 198, the transceiver 1222, and/or the antenna 1280. FIG. 6 illustrates an example of a UE 902 receiving an indication at 912. FIG. 4 and FIG. 8 illustrate example aspects of SSB adaptation, and FIGS. 5A and 5B illustrate examples of a DCI that may indicate the SSB adaptation. In some aspects, the SSB adaptation applies to all BWPs configured for the UE. In some aspects, the SSB adaptation applies to an active BWP in which an SSB adaptation indication is received and not to other BWPs configured for the UE. In some aspects, the SSB adaptation applies to a subset of BWPs configured for the UE. In some aspects, the SSB adaptation may be indicated in a downlink control information (DCI) (e.g., DCI format 2_9) or a medium access control-control element (MAC-CE) that indicates multiple SSB adaptations including an SSB periodicity value for each BWP configured for the UE. In some aspects, the SSB adaptation may be indicated in a downlink control information (DCI) or a medium access control-control element (MAC-CE) that indicates multiple SSB adaptations including an SSB periodicity value for a subset of BWPs configured for the UE.

At 1004, the UE switches from the first BWP to a second BWP. The switch may be performed, e.g., by one of more of the SSB monitor component 198, the transceiver 1222, and/or the antenna 1280. FIG. 9 illustrates an example of a UE switching from a first active downlink BWP to a second active downlink BWP. FIG. 7 and FIG. 8 illustrate example aspects relating to BWPs. In some aspects, the UE may receive a downlink control information (DCI) indicating a BWP switch from the first BWP to the second BWP, and the UE may switch BWPs based on reception of the DCI.

At 1006, the UE monitors for an SSB in the second BWP based on the SSB periodicity from the SSB adaptation for the first BWP or a different SSB periodicity based on a rule or an indication from a network node. The monitoring may be performed, e.g., by one of more of the SSB monitor component 198, the transceiver 1222, and/or the antenna 1280. FIG. 9 illustrates an example of monitoring for an SSB after a BWP switch, at 918. In an example where the SSB adaptation applies to all BWPs configured for the UE, the UE monitors for the SSB in the second BWP based on the SSB adaptation. If the SSB adaptation applies to an active BWP in which an SSB adaptation indication is received and not to other BWPs configured for the UE, the UE monitors for the SSB in the second BWP based on a different (or separate) SSB periodicity than the SSB adaptation. If the SSB adaptation applies to a subset of BWPs configured for the UE, the UE monitors for the SSB in the second BWP based on the SSB adaptation if the second BWP is in the subset and monitors for the SSB in the second BWP based on a different (or separate) SSB periodicity than the SSB adaptation if the second BWP is not in the subset. In some aspects, the UE monitors for the SSB in the second BWP based on a baseline SSB periodicity that is different than the SSB periodicity indicated in the SSB adaptation for the first BWP. In some aspects, the SSB adaptation for the first BWP is a last SSB periodicity indicated to the UE, and the UE monitors for the SSB in the second BWP based on the SSB periodicity indicated in the SSB adaptation as the last SSB periodicity indicated to the UE.

In some aspects, as shown at 1001, the UE may receive the indication of a second SSB periodicity associated with BWP switching, and the UE monitors for the SSB in the second BWP based on the second SSB periodicity. FIG. 9 illustrates an example of a UE 902 receiving a configuration of an SSB periodicity for BWP switches, at 910. In some aspects, a value of the second SSB periodicity may be based on the first BWP and the second BWP. In some aspects, the UE monitors for the SSB in the second BWP based on the SSB periodicity from the SSB adaptation for the first BWP or the different SSB periodicity based on a type of BWP switch.

In some aspects, as shown at 1003, the UE may receive a DCI indicating a BWP switch from the first BWP to the second BWP, where the DCI indicates an SSB periodicity value for the second BWP, the UE may monitor for the SSB in the second BWP based on the indicated SSB periodicity value from the DCI indicating the BWP switch. FIG. 9 illustrates an example of the UE 902 receiving a DCI indication.

The method may further include any of the aspects performed by the UE in the communication flow in FIG. 9, and/or any of the aspects described in connection with FIGS. 1-8.

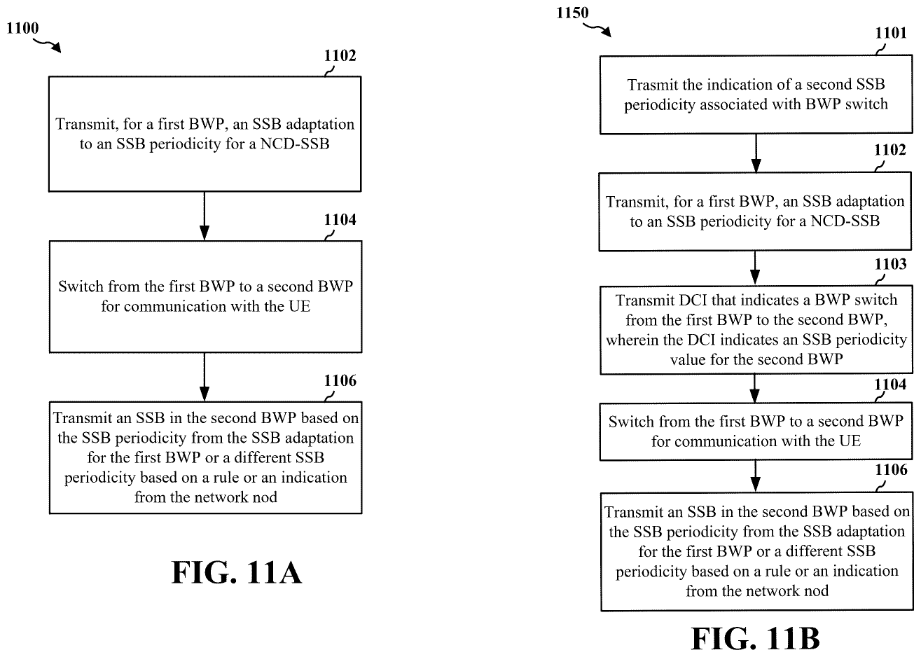

FIG. 11A is a flowchart 1100 of a method of wireless communication. The method may be performed by a network node that may correspond to a base station in aggregation or to one or more components of a base station (e.g., the base station 102, 310; the network node 904; the network entity 1302). The method enables the network to save energy through SSB adaptation while allowing for BWP switches for a UE. The aspects presented herein enable UEs to determine SSB periodicities to use for monitoring for SSBs when switching to a new BWP after receiving SSB adaptation information. The method enables a UE and a network node to coordinate so that the UE is aware of a periodicity for monitoring SSB, e.g., with an SSB adaptation, when the UE changes BWPs. The improved communication regarding the SSB adaptation in connection with BWP switches enables the network added flexibility and power savings through the use of SSB adaptation while maintaining effective communication with the UE.

At 1102, the network node transmits, for a first bandwidth part (BWP) configured for a user equipment (UE), a synchronization signal block (SSB) adaptation to an SSB periodicity for a non-cell defining (NCD) SSB. The transmission may be performed, e.g., by one or more of the SSB adaptation component 199, the transceiver 1346, and/or antenna 1380. In some aspects, the SSB adaptation applies to all BWPs configured for the UE. In some aspects, the SSB adaptation applies to an active BWP in which an SSB adaptation indication is received and not to other BWPs configured for the UE. In some aspects, the SSB adaptation applies to a subset of BWPs configured for the UE. In some aspects, the SSB adaptation may be indicated in a downlink control information (DCI) (e.g., DCI format 2_9) or a medium access control-control element (MAC-CE) that indicates multiple SSB adaptations including an SSB periodicity value for each BWP configured for the UE. In some aspects, the SSB adaptation may be indicated in a downlink control information (DCI) or a medium access control-control element (MAC-CE) that indicates multiple SSB adaptations including an SSB periodicity value for a subset of BWPs configured for the UE. FIG. 6 illustrates an example of a network node sending an indication for SSB adaptation at 912. FIG. 4 and FIG. 8 illustrate example aspects of SSB adaptation, and FIGS. 5A and 5B illustrate examples of a DCI that may indicate the SSB adaptation.

At 1104, the network node switches from the first BWP to a second BWP for communication with the UE. The switch may be performed, e.g., by one or more of the SSB adaptation component 199, the transceiver 1346, and/or antenna 1380. In some aspects, the network node may transmit a downlink control information (DCI) indicating a BWP switch from the first BWP to the second BWP. FIG. 9 illustrates an example of a network node switching BWPs at 913.

At 1106, the network node transmits an SSB in the second BWP based on the SSB periodicity from the SSB adaptation for the first BWP or a different SSB periodicity based on a rule or an indication from the network node. The transmission may be performed, e.g., by one or more of the SSB adaptation component 199, the transceiver 1346, and/or antenna 1380. FIG. 9 illustrates an example of a network node transmitting SSBs 920. FIGS. 4, 6, 7, and 8 illustrate example aspects for transmission of SSBs. In an example where the SSB adaptation applies to all BWPs configured for the UE, the network node transmits the SSB in the second BWP based on the SSB adaptation. If the SSB adaptation applies to an active BWP in which an SSB adaptation indication is received and not to other BWPs configured for the UE, the network node transmits the SSB in the second BWP based on a different (or separate) SSB periodicity than the SSB adaptation. If the SSB adaptation applies to a subset of BWPs configured for the UE, the network node transmits the SSB in the second BWP based on the SSB adaptation if the second BWP is in the subset and monitors for the SSB in the second BWP based on a different (or separate) SSB periodicity than the SSB adaptation if the second BWP is not in the subset. In some aspects, the network node transmits the SSB in the second BWP based on a baseline SSB periodicity that is different than the SSB periodicity indicated in the SSB adaptation for the first BWP. In some aspects, the SSB adaptation for the first BWP is a last SSB periodicity indicated to the UE, and the network node transmits the SSB in the second BWP based on the SSB periodicity indicated in the SSB adaptation as the last SSB periodicity indicated to the UE. In some aspects, the network node may transmit the indication of a second SSB periodicity associated with BWP switching, and the network node may transmit the SSB in the second BWP based on the second SSB periodicity. In some aspects, the network node may transmit the SSB in the second BWP based on the SSB periodicity from the SSB adaptation for the first BWP or the different SSB periodicity based on a type of BWP switch. In some aspects, where the DCI indicates an SSB periodicity value for the second BWP, network node may transmit the SSB in the second BWP based on the indicated SSB periodicity value from the DCI indicating the BWP switch.

The method may further include any of the aspects performed by the network node in the communication flow in FIG. 9, and/or any of the aspects described in connection with FIGS. 1-8.

FIG. 11B is a flowchart 1150 of a method of wireless communication. The method may be performed by a network node that may correspond to a base station in aggregation or to one or more components of a base station (e.g., the base station 102, 310; the network node 904; the network entity 1302). The method enables the network to save energy through SSB adaptation while allowing for BWP switches for a UE. The aspects presented herein enable UEs to determine SSB periodicities to use for monitoring for SSBs when switching to a new BWP after receiving SSB adaptation information. The method enables a UE and a network node to coordinate so that the UE is aware of a periodicity for monitoring SSB, e.g., with an SSB adaptation, when the UE changes BWPs. The improved communication regarding the SSB adaptation in connection with BWP switches enables the network added flexibility and power savings through the use of SSB adaptation while maintaining effective communication with the UE.

At 1102, the network node transmits, for a first bandwidth part (BWP) configured for a user equipment (UE), a synchronization signal block (SSB) adaptation to an SSB periodicity for a non-cell defining (NCD) SSB. The transmission may be performed, e.g., by one or more of the SSB adaptation component 199, the transceiver 1346, and/or antenna 1380. In some aspects, the SSB adaptation applies to all BWPs configured for the UE. In some aspects, the SSB adaptation applies to an active BWP in which an SSB adaptation indication is received and not to other BWPs configured for the UE. In some aspects, the SSB adaptation applies to a subset of BWPs configured for the UE. In some aspects, the SSB adaptation may be indicated in a downlink control information (DCI) (e.g., DCI format 2_9) or a medium access control-control element (MAC-CE) that indicates multiple SSB adaptations including an SSB periodicity value for each BWP configured for the UE. In some aspects, the SSB adaptation may be indicated in a downlink control information (DCI) or a medium access control-control element (MAC-CE) that indicates multiple SSB adaptations including an SSB periodicity value for a subset of BWPs configured for the UE. FIG. 6 illustrates an example of a network node sending an indication for SSB adaptation at 912. FIG. 4 and FIG. 8 illustrate example aspects of SSB adaptation, and FIGS. 5A and 5B illustrate examples of a DCI that may indicate the SSB adaptation.

At 1104, the network node switches from the first BWP to a second BWP for communication with the UE. The switch may be performed, e.g., by one or more of the SSB adaptation component 199, the transceiver 1346, and/or antenna 1380. In some aspects, the network node may transmit a downlink control information (DCI) indicating a BWP switch from the first BWP to the second BWP. FIG. 9 illustrates an example of a network node switching BWPs at 913.

At 1106, the network node transmits an SSB in the second BWP based on the SSB periodicity from the SSB adaptation for the first BWP or a different SSB periodicity based on a rule or an indication from the network node. The transmission may be performed, e.g., by one or more of the SSB adaptation component 199, the transceiver 1346, and/or antenna 1380. FIG. 9 illustrates an example of a network node transmitting SSBs 920. FIGS. 4, 6, 7, and 8 illustrate example aspects for transmission of SSBs. In an example where the SSB adaptation applies to all BWPs configured for the UE, the network node transmits the SSB in the second BWP based on the SSB adaptation. If the SSB adaptation applies to an active BWP in which an SSB adaptation indication is received and not to other BWPs configured for the UE, the network node transmits the SSB in the second BWP based on a different (or separate) SSB periodicity than the SSB adaptation. If the SSB adaptation applies to a subset of BWPs configured for the UE, the network node transmits the SSB in the second BWP based on the SSB adaptation if the second BWP is in the subset and monitors for the SSB in the second BWP based on a different (or separate) SSB periodicity than the SSB adaptation if the second BWP is not in the subset. In some aspects, the network node transmits the SSB in the second BWP based on a baseline SSB periodicity that is different than the SSB periodicity indicated in the SSB adaptation for the first BWP. In some aspects, the SSB adaptation for the first BWP is a last SSB periodicity indicated to the UE, and the network node transmits the SSB in the second BWP based on the SSB periodicity indicated in the SSB adaptation as the last SSB periodicity indicated to the UE.

In some aspects, as shown at 1101, the network node may transmit the indication of a second SSB periodicity associated with BWP switching, and the network node may transmit the SSB in the second BWP based on the second SSB periodicity. FIG. 9 illustrates an example of a network node transmitting a configuration of an SSB periodicity for BWP switches, at 910.

In some aspects, the network node may transmit the SSB in the second BWP based on the SSB periodicity from the SSB adaptation for the first BWP or the different SSB periodicity based on a type of BWP switch. FIG. 9 illustrates an example of a network node transmitting a DCI indication, at 912.

In some aspects, as shown at 1103, the network node may transmit DCI that indicates an SSB periodicity value for the second BWP, network node may transmit the SSB in the second BWP based on the indicated SSB periodicity value from the DCI indicating the BWP switch.

The method may further include any of the aspects performed by the network node in the communication flow in FIG. 9, and/or any of the aspects described in connection with FIGS. 1-8.

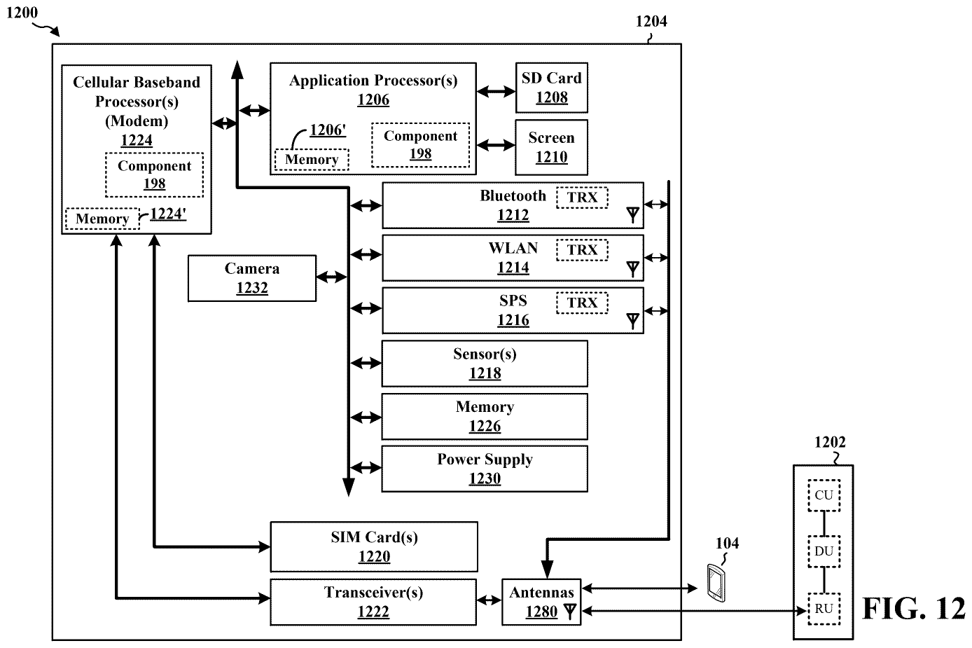

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to receive, for a first bandwidth part (BWP), a synchronization signal block (SSB) adaptation to an SSB periodicity for a non-cell defining (NCD) SSB; switch from the first BWP to a second BWP; and monitor for an SSB in the second BWP based on the SSB periodicity from the SSB adaptation for the first BWP or a different SSB periodicity based on a rule or an indication from a network node. The component 198 and/or the apparatus may be further configured to receive the indication of a second SSB periodicity associated with BWP switching, wherein the UE monitors for the SSB in the second BWP based on the second SSB periodicity. The component 198 and/or the apparatus may be further configured to receive a downlink control information (DCI) indicating a BWP switch from the first BWP to the second BWP, wherein the DCI indicates an SSB periodicity value for the second BWP, wherein the UE monitors for the SSB in the second BWP based on the indicated SSB periodicity value from the DCI indicating the BWP switch. The component 198 and/or the apparatus 1204 may be further configured to perform any of the aspects described in connection with the flowchart in FIGS. 10A and/or 10B or any of the aspects performed by the network node in FIG. 9. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, for a first bandwidth part (BWP), a synchronization signal block (SSB) adaptation to an SSB periodicity for a non-cell defining (NCD) SSB; means for switching from the first BWP to a second BWP; and means for monitoring for an SSB in the second BWP based on the SSB periodicity from the SSB adaptation for the first BWP or a different SSB periodicity based on a rule or an indication from a network node. The apparatus may further include means for receiving the indication of a second SSB periodicity associated with BWP switching, wherein the UE monitors for the SSB in the second BWP based on the second SSB periodicity. The apparatus may further include means for receiving a downlink control information (DCI) indicating a BWP switch from the first BWP to the second BWP, wherein the DCI indicates an SSB periodicity value for the second BWP, wherein the UE monitors for the SSB in the second BWP based on the indicated SSB periodicity value from the DCI indicating the BWP switch. The apparatus may further include means for performing any of the aspects described in connection with the flowchart in FIGS. 10A and/or 10B or any of the aspects performed by the UE in FIG. 9. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

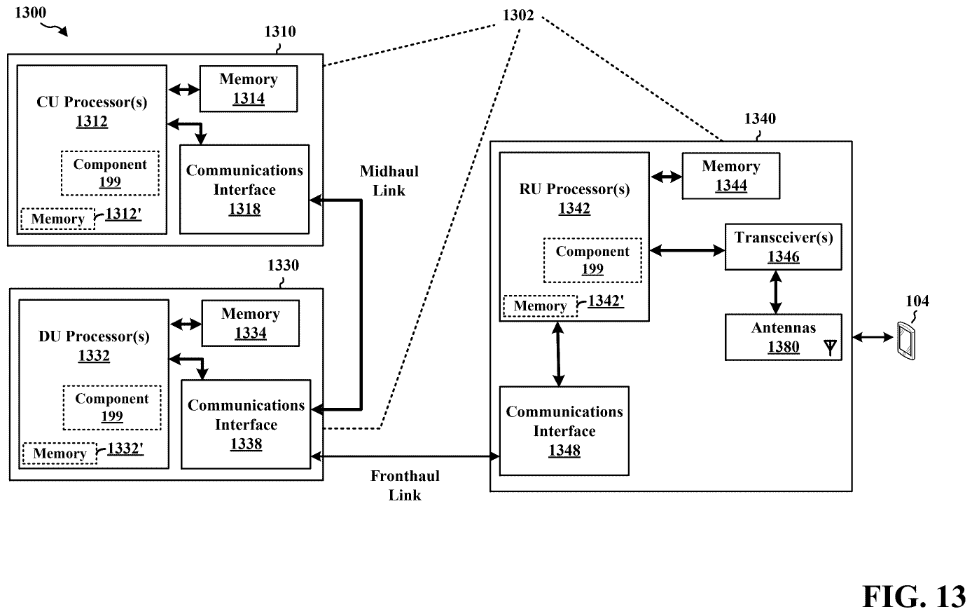

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a first bandwidth part (BWP) configured for a user equipment (UE), a synchronization signal block (SSB) adaptation to an SSB periodicity for a non-cell defining (NCD) SSB; switch from the first BWP to a second BWP for communication with the UE; and transmit an SSB in the second BWP based on the SSB periodicity from the SSB adaptation for the first BWP or a different SSB periodicity based on a rule or an indication from the network node. The component 199 and/or the network entity may be further configured to transmit the indication of a second SSB periodicity associated with BWP switching, wherein the UE monitors for the SSB in the second BWP based on the second SSB periodicity. The component 199 and/or the network entity may be further configured to transmit a downlink control information (DCI) indicating a BWP switch from the first BWP to the second BWP, wherein the DCI indicates an SSB periodicity value for the second BWP, wherein the UE monitors for the SSB in the second BWP based on the indicated SSB periodicity value from the DCI indicating the BWP switch. The component 199 and/or the network entity may be further configured to perform any of the aspects described in connection with the flowchart in FIGS. 11A and/or 11B or any of the aspects performed by the network node in FIG. 9. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting, for a first bandwidth part (BWP) configured for a user equipment (UE), a synchronization signal block (SSB) adaptation to an SSB periodicity for a non-cell defining (NCD) SSB; means for switching from the first BWP to a second BWP for communication with the UE; and means for transmitting an SSB in the second BWP based on the SSB periodicity from the SSB adaptation for the first BWP or a different SSB periodicity based on a rule or an indication from the network node. The network entity may further include means for transmitting the indication of a second SSB periodicity associated with BWP switching, wherein the UE monitors for the SSB in the second BWP based on the second SSB periodicity. The network entity may further include means for transmitting a downlink control information (DCI) indicating a BWP switch from the first BWP to the second BWP, wherein the DCI indicates an SSB periodicity value for the second BWP, wherein the UE monitors for the SSB in the second BWP based on the indicated SSB periodicity value from the DCI indicating the BWP switch. The apparatus may further include means for performing any of the aspects described in connection with the flowchart in FIGS. 11A and/or 11B or any of the aspects performed by the network node in FIG. 9. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a user equipment (UE), comprising: receiving, for a first bandwidth part (BWP), a synchronization signal block (SSB) adaptation to an SSB periodicity for a non-cell defining (NCD) SSB; switching from the first BWP to a second BWP; and monitoring for an SSB in the second BWP based on the SSB periodicity from the SSB adaptation for the first BWP or a different SSB periodicity based on a rule or an indication from a network node.

In aspect 2, the method of aspect 1 further includes that the SSB adaptation applies to all BWPs configured for the UE.

In aspect 3, the method of aspect 1 further includes that the SSB adaptation applies to an active BWP in which an SSB adaptation indication is received and not to other BWPs configured for the UE.

In aspect 4, the method of aspect 1 further includes that the SSB adaptation applies to a subset of BWPs configured for the UE.

In aspect 5, the method of aspect 1 further includes that the SSB adaptation is indicated in a downlink control information (DCI) or a medium access control-control element (MAC-CE) that indicates multiple SSB adaptations including an SSB periodicity value for each BWP configured for the UE.

In aspect 6, the method of aspect 1 or aspect 4 further includes that the SSB adaptation is indicated in a downlink control information (DCI) or a medium access control-control element (MAC-CE) that indicates multiple SSB adaptations including an SSB periodicity value for a subset of BWPs configured for the UE.

In aspect 7, the method of any of aspects 1 or 3-6 further includes that the UE monitors for the SSB in the second BWP based on a baseline SSB periodicity that is different than the SSB periodicity indicated in the SSB adaptation for the first BWP.

In aspect 8, the method of any of aspects 1-7 further includes that the SSB adaptation for the first BWP is a last SSB periodicity indicated to the UE, and wherein the UE monitors for the SSB in the second BWP based on the SSB periodicity indicated in the SSB adaptation as the last SSB periodicity indicated to the UE.

In aspect 9, the method of aspect 1, 3, or 4 further includes receiving the indication of a second SSB periodicity associated with BWP switching, wherein the UE monitors for the SSB in the second BWP based on the second SSB periodicity.

In aspect 10, the method of aspect 9 further includes a value of the second SSB periodicity is based on the first BWP and the second BWP.

In aspect 11, the method of aspect 1, 3, 4 further includes that the UE monitors for the SSB in the second BWP based on the SSB periodicity from the SSB adaptation for the first BWP or the different SSB periodicity based on a type of BWP switch.

In aspect 12, the method of aspect 1, 3, 4 further includes receiving a downlink control information (DCI) indicating a BWP switch from the first BWP to the second BWP, wherein the DCI indicates an SSB periodicity value for the second BWP, wherein the UE monitors for the SSB in the second BWP based on the indicated SSB periodicity value from the DCI indicating the BWP switch

Aspect 13 is an apparatus for wireless communication at a UE, comprising: at least one memory; and at least one processor coupled to the at least one memory, the at least one processor is configured to perform the method of any of aspects 1 to 12.

Aspect 14 is an apparatus for wireless communication at a UE, comprising means for performing each step in the method of any of aspects 1 to 12.

Aspect 15 is the apparatus of any of aspects 13-14, further comprising a transceiver configured to receive or to transmit in association with the method of any of aspects 1 to 12.

Aspect 16 is a computer-readable medium (e.g., a non-transitory computer-readable medium) storing computer executable code at a UE, the code when executed by at least one processor causes the at least one processor to perform the method of any of aspects 1 to 12.

Aspect 17 is a method of wireless communication at a network node, comprising: transmitting, for a first bandwidth part (BWP) configured for a user equipment (UE), a synchronization signal block (SSB) adaptation to an SSB periodicity for a non-cell defining (NCD) SSB; switching from the first BWP to a second BWP for communication with the UE; and transmitting an SSB in the second BWP based on the SSB periodicity from the SSB adaptation for the first BWP or a different SSB periodicity based on a rule or an indication from the network node.

In aspect 18, the method of aspect 17 further includes that the SSB adaptation applies to all BWPs configured for the UE.

In aspect 19, the method of aspect 17 further includes that the SSB adaptation applies to an active BWP in which an SSB adaptation indication is transmitted and not to other BWPs configured for the UE.

In aspect 20, the method of aspect 17 further includes that the SSB adaptation applies to a subset of BWPs configured for the UE.

In aspect 21, the method of any of aspects 17, 19, or 20 further includes that the SSB adaptation is indicated in a downlink control information (DCI) or a medium access control-control element (MAC-CE) that indicates multiple SSB adaptations including an SSB periodicity value for: each BWP configured for the UE, or a subset of BWPs configured for the UE.

In aspect 22, the method of any of aspects 17, 19, or 20 further includes that the network node transmits the SSB in the second BWP based on a baseline SSB periodicity that is different than the SSB periodicity indicated in the SSB adaptation for the first BWP.

In aspect 23, the method of any of aspects 17, 19, or 20 further includes that the SSB adaptation for the first BWP is a last SSB periodicity indicated to the UE, and wherein the network node transmits the SSB in the second BWP based on the SSB periodicity indicated in the SSB adaptation as the last SSB periodicity indicated to the UE.

In aspect 24, the method of any of aspects 17, 19, or 20 further includes transmitting the indication of a second SSB periodicity associated with BWP switching, wherein the SSB is transmitted in the second BWP based on the second SSB periodicity.

In aspect 25, the method of any of aspects 17, 19, or 20 further includes that the network node transmits the SSB in the second BWP based on the SSB periodicity from the SSB adaptation for the first BWP or the different SSB periodicity based on a type of BWP switch.

In aspect 26, the method of any of aspects 17, 19, or 20 further includes transmitting a downlink control information (DCI) indicating a BWP switch from the first BWP to the second BWP, wherein the DCI indicates an SSB periodicity value for the second BWP, wherein the SSB is transmitted in the second BWP based on the indicated SSB periodicity value from the DCI indicating the BWP switch.

Aspect 27 is an apparatus for wireless communication at a network node, comprising: at least one memory; and at least one processor coupled to the at least one memory, the at least one processor is configured to perform the method of any of aspects 17 to 26.

Aspect 28 is an apparatus for wireless communication at a network node, comprising means for performing each step in the method of any of aspects 17 to 26.

Aspect 29 is the apparatus of any of aspects 27-28, further comprising a transceiver configured to receive or to transmit in association with the method of any of aspects 17 to 26.

Aspect 30 is a computer-readable medium (e.g., a non-transitory computer-readable medium) storing computer executable code at a network node, the code when executed by at least one processor causes the at least one processor to perform the method of any of aspects 17 to 26.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, for a first bandwidth part (BWP), a synchronization signal block (SSB) adaptation to an SSB periodicity for a non-cell defining (NCD) SSB;
switch from the first BWP to a second BWP; and
monitor for an SSB in the second BWP based on the SSB periodicity from the SSB adaptation for the first BWP or a different SSB periodicity based on a rule or an indication from a network node.

2. The apparatus of claim 1, wherein the SSB adaptation applies to all BWPs configured for the UE.

3. The apparatus of claim 1, wherein the SSB adaptation applies to an active BWP in which an SSB adaptation indication is received and not to other BWPs configured for the UE.

4. The apparatus of claim 1, wherein the SSB adaptation applies to a subset of BWPs configured for the UE.

5. The apparatus of claim 1, wherein the SSB adaptation is indicated in a downlink control information (DCI) or a medium access control-control element (MAC-CE) that indicates multiple SSB adaptations that include an SSB periodicity value for each BWP configured for the UE.

6. The apparatus of claim 1, wherein the SSB adaptation is indicated in a downlink control information (DCI) or a medium access control-control element (MAC-CE) that indicates multiple SSB adaptations that include an SSB periodicity value for a subset of BWPs configured for the UE.

7. The apparatus of claim 1, wherein, to monitor for the SSB, the at least one processor is configured to:
monitor for the SSB in the second BWP based on a baseline SSB periodicity that is different than the SSB periodicity indicated in the SSB adaptation for the first BWP.

8. The apparatus of claim 1, wherein the SSB adaptation for the first BWP is a last SSB periodicity indicated to the UE, and wherein, to monitor for the SSB, the at least one processor is configured to:
monitor for the SSB in the second BWP based on the SSB periodicity indicated in the SSB adaptation as the last SSB periodicity indicated to the UE.

9. The apparatus of claim 1, wherein the at least one processor is further configured to:
receive the indication of a second SSB periodicity associated with BWP switching, wherein the UE monitors for the SSB in the second BWP based on the second SSB periodicity.

10. The apparatus of claim 9, wherein a value of the second SSB periodicity is based on the first BWP and the second BWP.

11. The apparatus of claim 1, wherein, to monitor for the SSB, the at least one processor is configured to:
monitor for the SSB in the second BWP based on the SSB periodicity from the SSB adaptation for the first BWP or the different SSB periodicity based on a type of BWP switch.

12. The apparatus of claim 1, further comprising a transceiver coupled to the at least one processor, wherein the at least one processor is further configured to:
receive, via the transceiver, a downlink control information (DCI) that indicates a BWP switch from the first BWP to the second BWP, wherein the DCI indicates an SSB periodicity value for the second BWP, wherein the UE monitors for the SSB in the second BWP based on the indicated SSB periodicity value from the DCI that indicates the BWP switch.

13. An apparatus for wireless communication at a network node, comprising:
at least one memory; and
at least one processor coupled to the at least one memory and, based at least in part on information stored in the at least one memory, the at least one processor is configured to:
transmit, for a first bandwidth part (BWP) configured for a user equipment (UE), a synchronization signal block (SSB) adaptation to an SSB periodicity for a non-cell defining (NCD) SSB;
switch from the first BWP to a second BWP for communication with the UE; and
transmit an SSB in the second BWP based on the SSB periodicity from the SSB adaptation for the first BWP or a different SSB periodicity based on a rule or an indication from the network node.

14. The apparatus of claim 13, wherein the SSB adaptation applies to:
all BWPs configured for the UE,
an active BWP in which an SSB adaptation indication is transmitted and not to other BWPs configured for the UE, or
a subset of BWPs configured for the UE.

15. The apparatus of claim 13, wherein the SSB adaptation is indicated in a downlink control information (DCI) or a medium access control-control element (MAC-CE) that indicates multiple SSB adaptations that include an SSB periodicity value for:
each BWP configured for the UE, or
a subset of BWPs configured for the UE.

16. The apparatus of claim 13, wherein, to transmit the SSB, the at least one processor is configured to:
transmit the SSB in the second BWP based on a baseline SSB periodicity that is different than the SSB periodicity indicated in the SSB adaptation for the first BWP.

17. The apparatus of claim 13, wherein the SSB adaptation for the first BWP is a last SSB periodicity indicated to the UE, and wherein, to transmit the SSB, the at least one processor is configured to:
transmit the SSB in the second BWP based on the SSB periodicity indicated in the SSB adaptation as the last SSB periodicity indicated to the UE.

18. The apparatus of claim 13, wherein the at least one processor is further configured to:
transmit the indication of a second SSB periodicity associated with BWP switching, wherein the SSB is transmitted in the second BWP based on the second SSB periodicity.

19. The apparatus of claim 13, wherein, to transmit the SSB, the at least one processor is configured to:
transmit the SSB in the second BWP based on the SSB periodicity from the SSB adaptation for the first BWP or the different SSB periodicity based on a type of BWP switch.

20. The apparatus of claim 13, further comprising a transceiver coupled to the at least one processor, wherein the at least one processor is further configured to:
transmit, via the transceiver, a downlink control information (DCI) that indicate a BWP switch from the first BWP to the second BWP, wherein the DCI indicates an SSB periodicity value for the second BWP, wherein the SSB is transmitted in the second BWP based on the indicated SSB periodicity value from the DCI that indicate the BWP switch.
